(19) United States
(12) Patent Application Publication
(10) Pub. No.: US 2025/0372600 A1
(43) Pub. Date: Dec. 4, 2025

(54) METHOD FOR PROCESSING ELECTRODE SHEET AND ELECTRODE FABRICATION SYSTEM

(71) Applicants: Prime Planet Energy & Solutions, Inc., Tokyo (JP); TOYOTA JIDOSHA KABUSHIKI KAISHA, Aichi-ken (JP)

(72) Inventors: Shinji YOSHIOKA, Himeji-shi (JP); Toshiatsu ODAI, Himeji-shi (JP); Yoshihiko SASAKI, Himeji-shi (JP); Kengo HAGA, Nagoya-shi (JP); Tomofumi HIRUKAWA, Toyota-shi (JP); Yuki MASUDA, Kariya-shi (JP)

(21) Appl. No.: 19/209,821

(22) Filed: May 16, 2025

(30) Foreign Application Priority Data
May 28, 2024 (JP) 2024-086695

(51) Int. Cl. H01M 4/04; H01M 10/04

(52) U.S. Cl. CPC H01M 4/0435; H01M 10/0404; H01M 10/0481

(57) ABSTRACT

A method for processing an electrode sheet includes a preparation step and an extension step. In the preparation step, a band-shaped electrode sheet in which an electrode active material layer is located on a current collector of metal foil, and the current collector includes a non-formed portion on which no electrode active material layer is located. In the extension step, the non-formed portion is extended by pressing a rubber roll against the non-formed portion of the electrode sheet while conveying the electrode sheet. The extension step uses the rubber roll with which an amount of change of an extension rate of the non-formed portion extended by the rubber roll becomes less than or equal to a predetermined reference change amount in a predetermined reference time.

### CROSS REFERENCE TO RELATED APPLICATIONS

This application claims the benefit of priority to Japanese Patent No. 2024-086695 filed on May 28, 2024. The entire contents of this application are hereby incorporated herein by reference.

### BACKGROUND

The present disclosure relates to a method for processing an electrode sheet and an electrode fabrication system.

Japanese Patent Application Publication No. 2023-36089, for example, discloses a method for fabricating an electrode. In this method, in a precursor sheet (i.e., an electrode sheet) including metal foil, a coated portion coated with an electrode material on the metal foil, and an uncoated portion not coated with the electrode material on the metal foil, the uncoated portion is pressed by a pair of elastic rolls (i.e., rubber rolls).

For example, when the uncoated portion is pressed with rolls other than elastic rolls, voids can occur by a tensile force or other reasons inside the uncoated portion. These voids might cause breakage of the uncoated portion. By pressing the uncoated portion with the pair of elastic rolls, a compressive force and a deformation force can be applied to the same portion of the uncoated portion. This compressive force occurs by deformation of the elastic rolls caused by contact with the pair of elastic rolls. Accordingly, the uncoated portion can be extended with suppression of breakage of the uncoated portion.

### SUMMARY

In the method for fabricating an electrode disclosed in Japanese Patent Application Publication No. 2023-36089, when the elastic rolls are replaced with new elastic rolls and the uncoated portion of the precursor sheet is extended with the new elastic rolls, the extension rate of the uncoated portion might vary. The extension rate of the uncoated portion is preferably stable near a predetermined value.

A method for processing an electrode sheet disclosed here includes: a preparation step of preparing a band-shaped electrode sheet in which an electrode active material layer is located on a current collector of metal foil, and the current collector including a non-formed portion on which no electrode active material layer is located; and an extension step of extending the non-formed portion by pressing a rubber roll against the non-formed portion of the electrode sheet while conveying the electrode sheet. The extension step uses the rubber roll with which an amount of change of an extension rate of the non-formed portion extended by the rubber roll becomes less than or equal to a predetermined reference change amount in a predetermined reference time.

With the method for processing the electrode sheet disclosed here, the non-formed portion can be extended by using the rubber roll processed to stabilize the extension rate of the non-formed portion of the electrode sheet. This can suppress variation of the degree of extension of the non-formed portion.

An electrode fabrication system disclosed here includes: a preloader that applies a load to a rubber roll until an amount of change of an extension rate of a non-formed portion of an electrode sheet extended by the rubber roll in a predetermined reference time becomes less than or equal to a predetermined reference change amount, the rubber roll being configured to be pressed against the non-formed portion in which a current collector of metal foil is exposed to extend the non-formed portion; and an extender that conveys the electrode sheet with the rubber roll pressed against the non-formed portion of the electrode sheet after application of a load to the rubber roll by the preloader.

### BRIEF DESCRIPTION OF THE DRAWINGS

FIG. 1 is a flowchart of fabrication by an electrode fabrication system.

FIG. 2 is a schematic view of an electrode sheet.

FIG. 3 is a schematic side view of the electrode fabrication system.

FIG. 4 is a front view of a roll pressing machine.

FIG. 5 is a cross-sectional view taken along line A-A in FIG. 4.

FIG. 6 is a block diagram of the electrode fabrication system.

FIG. 7 is a flowchart showing a procedure of a method for processing an electrode sheet.

FIG. 8 is a graph showing a relationship between the time required for creep removal of target pressing rolls and an extension rate of uncoated portions of the electrode sheet.

FIG. 9 illustrates a state where a load is applied to the target pressing rolls in the roll pressing machine and corresponds to FIG. 5.

### DETAILED DESCRIPTION

A preferred embodiment of the technique disclosed here will be described hereinafter with reference to the drawings. The preferred embodiment described herein is, of course, not intended to particularly limit the present disclosure. Each drawing is a schematic view and does not necessarily strictly reflect an actual product. Members and parts having the same functions are denoted by the same reference numerals as appropriate, and description for the same members and parts will not be repeated as appropriate.

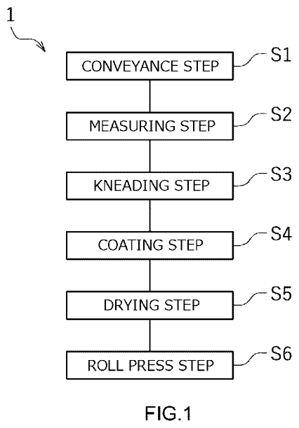

FIG. 1 is a flowchart of fabrication by an electrode fabrication system 1. As illustrated in FIG. 1, fabrication in the electrode fabrication system 1 includes conveyance step S1, measuring step S2, kneading step S3, coating step S4, drying step S5, and roll press step S6. The fabrication in the electrode fabrication system 1 may include other steps.

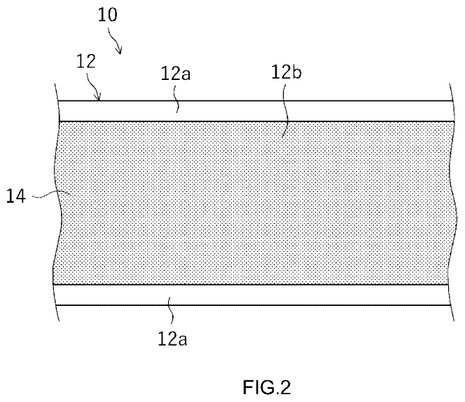

In the electrode fabrication system 1, an electrode sheet 10 (see FIG. 2) constituting a power storage device is fabricated. The electrode sheet 10 includes a positive electrode sheet or a negative electrode sheet of an electrode body housed inside the power storage device. The power storage device refers to a device enabling repetitive charging and discharging, and generally includes so-called storage batteries (i.e., chemical cells) such as a lithium ion secondary battery, a nickel hydrogen battery, and a nickel-cadmium battery and capacitors (i.e., physical cells) such as an electric double layer capacitor. Hereinafter, as an example, the electrode fabrication system 1 that fabricates an electrode sheet 10 will be described together with a configuration of the electrode sheet 10 for use in lithium ion secondary batteries.

FIG. 2 is a schematic view of the electrode sheet 10. As illustrated in FIG. 2, the electrode sheet 10 has an elongated band shape. The electrode sheet 10 includes a current collector 12 and an electrode active material layer 14. The current collector 12 is a member of metal foil. The current collector 12 is an elongated band-shaped metal member. As the current collector 12, a metal material having required conductivity can be used. As positive electrode current collecting foil as an example of the current collector 12, aluminium or an aluminium alloy can be used, for example. As negative electrode current collecting foil as an example of the current collector 12, copper or a copper alloy can be used, for example. The electrode active material layer 14 is applied onto a predetermined portion of the current collector 12. The electrode active material layer 14 is formed on at least one surface of the band-shaped current collector 12. In this preferred embodiment, the electrode active material layer 14 is formed on each surface of the current collector 12. The electrode active material layer 14 contains an electrode active material. As a positive electrode active material that is an example of the electrode active material, a lithium transition metal composite oxide can be used, for example. As a negative electrode active material that is an example of the electrode active material, a carbon material, a silicon-based material, and a mixed oxide thereof can be used, for example. The electrode active material layer may include an additive other than the electrode active material, such as a binder or a conductive material.

The electrode sheet 10 is formed by applying electrode mixture slurry as the electrode active material layer 14 onto the current collector 12 and drying the slurry. The current collector 12 includes uncoated portions 12a and a coated portion 12b. The uncoated portions 12a are an example of a non-formed portion. The uncoated portions 12a are portions of the current collector 12 on which the electrode active material layer 14 is not formed. In other words, the uncoated portions 12a are portions of the current collector 12 that are not coated with the electrode active material layer 14. The uncoated portions 12a are defined at predetermined positions of the current collector 12 in the width direction along the length direction. The uncoated portions 12a are defined along the length direction on end portions of the electrode sheet 10 in the width direction. In this preferred embodiment, the uncoated portions 12a are defined at both ends of the electrode sheet 10 in the width direction. The coated portion 12b is located between the uncoated portions 12a at both ends of the electrode sheet 10. The coated portion 12b is a portion of the current collector 12 on which the electrode active material layer 14 is formed (i.e., applied by coating). The electrode mixture slurry is applied onto the coated portion 12b. In this manner, the electrode active material layer 14 is formed on the coated portion 12b of the current collector 12. That is, the electrode active material layer 14 is located between the uncoated portions 12a at both ends of the electrode sheet 10 in the width direction. The electrode active material layer 14 is formed on a portion of the current collector 12 except for the uncoated portions 12a. Although not shown, a protective layer including an inorganic filler may be located at the boundary between the uncoated portions 12a and the coated portion 12b. In the case where the protective layer is formed, when rubber rolls of EPS are pressed against the protective layer, elongation percentages of a portion with the protective layer and a portion without the protective layer might not match.

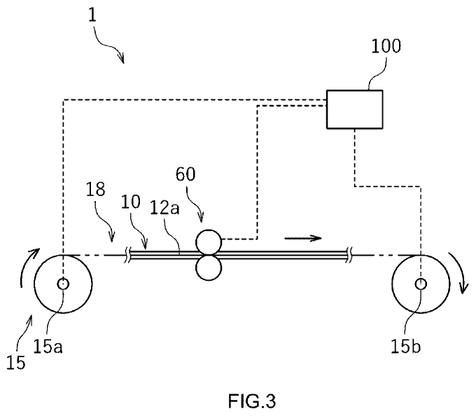

In conveyance step S1 shown in FIG. 1, the electrode sheet 10 is conveyed. FIG. 3 is a schematic side view of the electrode fabrication system 1. In this preferred embodiment, the electrode fabrication system 1 includes a conveyor 15. The conveyance step S1 can be implemented by the conveyor 15. The conveyor 15 conveys the electrode sheet 10. The conveyor 15 employs, for example, a motor. The conveyor 15 includes an unwinding roll 15a and a winding roll 15b such that the electrode sheet 10 is conveyed at a predetermined conveyance speed. The electrode sheet 10 is wound around the unwinding roll 15a and the winding roll 15b. The unwinding roll 15a is disposed upstream of a roll pressing machine 60 described later in the conveyance direction. The winding roll 15b is disposed downstream of the roll pressing machine 60 in a conveyance direction. The conveyor 15 is not limited to the configuration including the unwinding roll 15a and the winding roll 15b. For example, the conveyor 15 may include a roll other than the unwinding roll 15a and the winding roll 15b. The conveyor 15 conveys the electrode sheet 10 along a predetermined conveyance path 18.

In measuring step S2 shown in FIG. 1, materials for the electrode active material layer 14 (see FIG. 2) are measured. The measurement can be achieved using a measuring device (not shown) equipped with, for example, a balance or a load cell. The measured materials for the measured electrode active material layer 14 are mixed in kneading step S3. Kneading step S3 can be achieved by a kneading device (not shown). The electrode active material layer 14 made into slurry by the kneading device is formed into the current collector 12 (see FIG. 2) in coating step S4. In this step, the electrode active material layer 14 is formed by coating on the current collector 12. The electrode active material layer 14 may be formed on the current collector 12 by a method other than coating. Coating step S4 can be achieved by, for example, a coating device (not shown) such as a slit coater, a gravure coater, a die coater, or a comma coater. In drying step S5 shown in FIG. 1, the applied slurry materials for the electrode active material layer 14 are dried. Drying step S5 can be achieved by a drying device (not shown) that emits, for example, hot air or an infrared ray.

In roll press step S6 shown in FIG. 1, the electrode sheet 10 is pressed. The electrode sheet 10 is extended by pressing. The roll press step S6 can be achieved by the roll pressing machine 60 shown in FIG. 3. The electrode fabrication system 1 includes the roll pressing machine 60. As illustrated in FIG. 3, the electrode sheet 10 is pressed by the roll pressing machine 60 in the middle of the conveyance path 18. The electrode sheet 10 is supplied to the roll pressing machine 60 by the unwinding roll 15a. The electrode sheet 10 pressed by the roll pressing machine 60 is conveyed toward the winding roll 15b and wound by the winding roll 15b. The electrode fabrication system 1 includes a controller 100 that controls the unwinding roll 15a, the winding roll 15b, and the roll pressing machine 60.

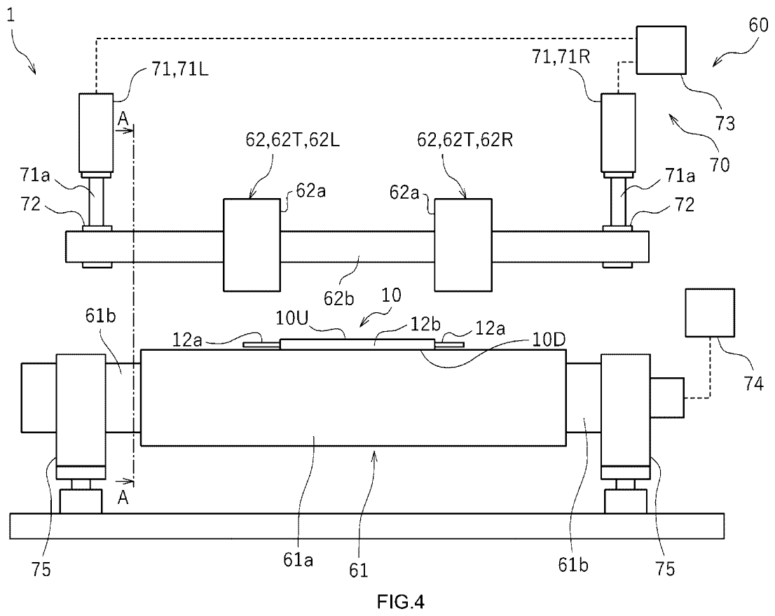

FIG. 4 is a front view of the roll pressing machine 60. The roll pressing machine 60 according to this preferred embodiment presses the uncoated portions 12a of the electrode sheet 10 by rubber rolls before or after the coated portion 12b of the electrode sheet 10 is pressed. When the uncoated portions 12a are pressed by the rubber rolls, under a reaction force of elastic deformation and compressive deformation of the rubber rolls, the portion pressed by the rubber rolls are pressed and pulled. Consequently, the uncoated portions 12a can be extended with breakage of the uncoated portions 12a suppressed. For this function, the device that presses the uncoated portions 12a of the electrode sheet 10 by the rubber rolls can be referred to as an elasticity powered stretching (EPS) device. The roll pressing machine 60 is an example of an extender, and conveys the electrode sheet 10 while pressing rolls 62 described later against the uncoated portions 12a of the electrode sheet 10. The electrode fabrication system 1 may include a device that presses the coated portion 12b of the electrode sheet 10, other than the roll pressing machine 60.

As illustrated in FIG. 4, the roll pressing machine 60 includes a support roll 61, the pressing rolls 62, and a pressing force adjusting mechanism 70.

The support roll 61 is located on the conveyance path 18 (see FIG. 3). The support roll 61 supports a first surface 10D of the electrode sheet 10 conveyed along the conveyance path 18, along the width direction of the electrode sheet 10. In this preferred embodiment, the electrode sheet 10 includes the first surface 10D and a second surface 10U. In this preferred embodiment, the first surface 10D constitutes a lower surface of the electrode sheet 10. The second surface 10U is a surface of the electrode sheet 10 opposite to the first surface 10D. In this preferred embodiment, the second surface 10U constitutes an upper surface of the electrode sheet 10. The support roll 61 is located below the pressing rolls 62. The support roll 61 is a rubber roll that presses the uncoated portions 12a of the electrode sheet 10 together with the pressing rolls 62. The support roll 61 is an example of another rubber roll, and is an example, a pressing target. In this preferred embodiment, the support roll 61 includes a body 61a and both axial portions 61b.

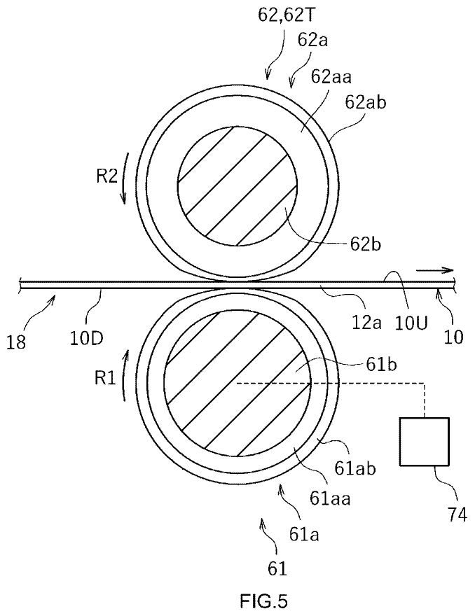

FIG. 5 is a cross-sectional view taken along line A-A in FIG. 4. FIG. 5 illustrates a state where the uncoated portions 12a are pressed by the support roll 61 and the pressing rolls 62. As illustrated in FIG. 5, the body 61a includes an axis portion 61aa and a rubber portion 61ab. The axis portion 61aa is made of a metal. A material for the axis portion 61aa is not particularly limited, and is, for example, a material having a relatively high hardness such as SUS304 (stainless steel material). The rubber portion 61ab covers at least the outer circumference surface of the axis portion 61aa. A material for the rubber portion 61ab is, for example, nitrile rubber (NBR). The support roll 61 presses the uncoated portions 12a of the electrode sheet 10 with the rubber portion 61ab.

The support roll 61 rotates in a predetermined direction by a roll driver 74 described later (see FIG. 4). In this preferred embodiment, the support roll 61 rotates in a direction of arrow R1 shown in FIG. 5. At this time, the electrode sheet 10 is conveyed from the left to the right when seen in the drawing of FIG. 5. That is, in FIG. 5, the left is an upstream side in the conveyance direction, and the right is a downstream side in the conveyance direction.

As illustrated in FIG. 4, the both axial portions 61b are inserted in the body 61a. The both axial portions 61b are inserted in the axis portion 61aa (see FIG. 5) of the body 61a. The both axial portions 61b extend to the outside of the support roll 61 in the axial direction. Although not shown, a bearing and a gap screw that adjusts a gap between the support roll 61 and the pressing rolls 62, for example, may be attached to the both axial portions 61b.

As illustrated in FIG. 5, the pressing rolls 62 are disposed to face the support roll 61 on the second surface 10U (upper surface in this preferred embodiment) of the electrode sheet 10. The pressing rolls 62 sandwich the uncoated portions 12a between the pressing rolls 62 and the support roll 61 except for the coated portion 12b (see FIG. 2) of the electrode sheet 10. In this preferred embodiment, the positions of the axial centers of the pressing rolls 62 and the position of the axial center of the support roll 61 are aligned in the top-bottom direction. As illustrated in FIG. 4, the pressing rolls 62 presses the uncoated portions 12a of the electrode sheet 10 together with the support roll 61. The pressing rolls 62 are an example of a rubber roll. In this preferred embodiment, the rubber roll refers to a roll at least whose outer circumference surface is made of rubber. The pressing rolls 62 are not located above the coated portion 12b of the electrode sheet 10. In this preferred embodiment, as described above, two uncoated portions 12a of the electrode sheet 10 are defined at both ends of the electrode sheet 10 in the width direction. Thus, as illustrated in FIG. 4, the pressing rolls 62 are respectively located above the uncoated portions 12a at both ends of the electrode sheet 10 in the width direction. The number of the pressing rolls 62 is two. The number of the uncoated portions 12a may be one. In the case where the number of the uncoated portions 12a is one, the number of the pressing rolls 62 may be one. In the two pressing rolls 62, the left pressing roll 62 will also be referred to as a pressing roll 62L, and the right pressing roll 62 will also be referred to as a pressing roll 62R. In the case where the description applies to both pressing rolls 62L and 62R, the term “pressing roll 62” will be used as appropriate. The pressing rolls 62 (the pressing rolls 62L and 62R in this preferred embodiment) are replaceable and detachable from the roll pressing machine 60. In this preferred embodiment, the pressing roll 62 includes the body 62a and the both axial portions 62b.

As illustrated in FIG. 5, the body 62a includes an axis portion 62aa and a rubber portion 62ab. The axis portion 62aa is made of a metal. A material for the axis portion 62aa is not particularly limited, and is, for example, a material having a relatively high hardness such SUS304 as (stainless steel material). The rubber portion 62ab covers at least the outer circumference surface of the axis portion 62aa. A material for the rubber portion 62ab is not particularly limited and is, for example, nitrile rubber (NBR). The pressing roll 62 presses the uncoated portion 12a of the electrode sheet 10 with the rubber portion 62ab.

As illustrated in FIG. 4, the both axial portions 62b are inserted in the body 62a. The both axial portion 62b is inserted in the axis portion 62aa (see FIG. 5) of the body 62a. The both axial portions 62b extend to the outside of the two pressing rolls 62 in the axial direction. Although not shown, a bearing and a gap screw that adjusts a gap between the support roll 61 and the pressing rolls 62, for example, may be attached to the both axial portions 62b.

As illustrated in FIG. 5, when the support roll 61 rotates in the direction of arrow R1 with the electrode sheet 10 sandwiched between the support roll 61 and the pressing rolls 62, the pressing rolls 62 are subjected to a force of rotation in the direction of arrow R2 through the electrode sheet 10. On the other hand, when the support roll 61 and the pressing rolls 62 are in contact with each other without the electrode sheet 10, the pressing rolls 62 are subjected to a force of rotation in the direction of arrow R2 by the rotation force of the support roll 61. Accordingly, the pressing rolls 62 rotate in the direction of arrow R2. That is, the pressing rolls 62 are driven rolls that rotate in synchronization with rotation of the support roll 61.

As illustrated in FIG. 4, the pressing force adjusting mechanism 70 is a mechanism that adjusts a force with which the pressing rolls 62 press the electrode sheet 10 (i.e., pressing force). The pressing force adjusting mechanism 70 includes press cylinders 71, roll chocks 72, a cylinder driver 73, a roll driver 74, and supporters 75.

The press cylinder 71 presses the pressing rolls 62 against the support roll 61. One press cylinder 71 is disposed on each outer side of one of both ends of the corresponding pressing roll 62. In this example, in FIG. 4, the press cylinder 71 at the left of the electrode sheet 10 will also be referred to as a press cylinder 71L, and the press cylinder 71 at the right of the electrode sheet 10 will also be referred to as a press cylinder 71R. In description common to the press cylinders 71L and 71R, the term “press cylinder 71” will also be used. In this preferred embodiment, the press cylinders 71 are pneumatic cylinders. The press cylinders 71 include rods 71a. The rods 71a are connected to the roll chocks 72. The roll chocks 72 rotatably support the both axial portions 62b of the pressing rolls 62. When the press cylinders 71 are driven and the rods 71a move downward, the pressing rolls 62 move downward. With the downward movement of the pressing rolls 62, the pressing rolls 62 are pressed by the support roll 61, and the pressing force increases. When the press cylinders 71 are driven and the rods 71a move upward, the pressing rolls 62 move upward. The upward movement of the pressing rolls 62 reduces the pressing force.

The cylinder driver 73 presses the pressing rolls 62 against the support roll 61. The cylinder driver 73 is connected to the press cylinders 71. The cylinder driver 73 drives the press cylinders 71. In this manner, the rods 71a of the press cylinders 71 move upward and downward. In this preferred embodiment, the cylinder driver 73 is configured to drive the press cylinder 71L and the press cylinder 71R independently of each other. That is, the cylinder driver 73 drives the pressing rolls 62 located above the uncoated portions 12a at both ends of the electrode sheet 10 in the width direction, independently of each other. The cylinder driver 73 is connected to the controller 100 (see FIG. 3).

The roll driver 74 is connected to the support roll 61. The roll driver 74 rotates the support roll 61. In this preferred embodiment, the roll driver 74 rotates the support roll 61 in the direction of arrow R1 in FIG. 5. The roll driver 74 is not limited to a particular configuration, and is constituted by an electric motor and gears, for example. The roll driver 74 is connected to the controller 100 (see FIG. 3). The roll driver 74 may rotate the pressing rolls 62.

The supporters 75 support the support roll 61. The supporters 75 support the both axial portions 61b of the support roll 61.

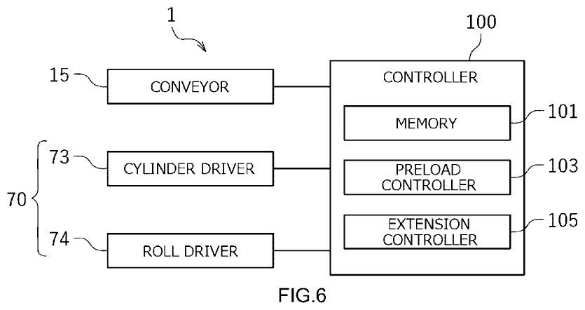

The controller 100 illustrated in FIG. 3 controls the roll pressing machine 60 as described above. The configuration of the controller 100 is not particularly limited. The controller 100 is, for example, a microcomputer. A hardware architecture of the microcomputer is not particularly limited, and includes, for example, an I/F, a CPU, a ROM, a RAM, and a memory device. FIG. 6 is a block diagram of the electrode fabrication system 1. As illustrated in FIG. 6, the controller 100 is communicably connected to, for example, the conveyor 15 and the pressing force adjusting mechanism 70 (specifically, the cylinder driver 73 and the roll driver 74). The controller 100 controls the conveyor 15 and the cylinder driver 73 and the roll driver 74 of the pressing force adjusting mechanism 70. In this preferred embodiment, the controller 100 includes a memory 101, a preload controller 103, and an extension controller 105. Each of the memory 101, the preload controller 103, and the extension controller 105 may be implemented by one or more processors, or may be implemented by a circuit.

The electrode fabrication system 1 according to this preferred embodiment has been described above. As illustrated in FIG. 4, in the electrode fabrication system 1, the pressing rolls 62 as an example of rubber rolls (the pressing rolls 62L and 62R in this preferred embodiment) are detachable and replaceable. In the pressing rolls 62, especially rubber portions (rubber portions 62ab in this preferred embodiment) are consumables, and when used for a predetermined time or in number, the pressing rolls 62 are replaced with new pressing rolls 62. In the following description, new pressing rolls 62 will also be referred to as target pressing rolls 62T (see FIG. 5). As illustrated in FIG. 5, when the target pressing rolls 62T are pressed against the uncoated portions 12a of the electrode sheet 10 to extend the uncoated portions 12a, the extension rate of the uncoated portions 12a varies in some cases. For example, when the uncoated portions 12a are extended using the new target pressing rolls 62T, the extension rate of the uncoated portions 12a is low at first, and then gradually increases with time. When a predetermined time has elapsed with use of the target pressing rolls 62T, the extension rate of the uncoated portions 12a is stabilized.

In view of this, according to this preferred embodiment, even new target pressing rolls 62T enable extension of the uncoated portions 12a with a stable extension rate of the uncoated portions 12a of the electrode sheet 10. Inventors of the present disclosure studied a cause of initial decrease in the extension rate of the uncoated portions 12a with the use of new target pressing rolls 62T. Through various studies, the inventors found that in a case where the target pressing rolls 62T as rubber rolls are new, so-called creep has occurred in the target pressing rolls 62T, and thus, the extension rate of the uncoated portions 12a is low and is not stable. That is, the inventors found that the extension rate of the uncoated portions 12a is easily stabilized by removing creep of the target pressing rolls 62T.

For example, when a load is applied to rubber, the rubber undergoes a corresponding amount of elastic deformation. Then, when a constant load is continuously applied to the rubber in the state of constant elastic deformation, the deformation of the rubber gradually increases with time. This phenomenon is called creep. In this preferred embodiment, while the target pressing rolls 62T are pressed against the electrode sheet 10, the target pressing rolls 62T is subjected to a constant load. Thus, by continuously pressing the new target pressing rolls 62T against electrode sheet 10, a constant load is continuously applied, and accordingly, deformation of rubber increases with time so that creep occurs. Creep of rubber easily occurs in new rubber. Creep of rubber is removed when a state under a load continues until a predetermined time elapses, for example, so that elastic deformation of rubber is stabilized. In this preferred embodiment, a process of continuously applying a load to the new target pressing rolls 62T to stabilize elastic deformation of rubber of the pressing rolls 62 will be referred to as “creep removal.”

In this preferred embodiment, in replacing the pressing rolls 62 attached to the roll pressing machine 60 with new target pressing rolls 62T, creep removal is performed by applying a load to the new target pressing rolls 62T. Then, the target pressing rolls 62T subjected to creep removal are used and pressed against the uncoated portions 12a of the electrode sheet 10, thereby extending the uncoated portions 12a while stabilizing the extension rate of the uncoated portions 12a.

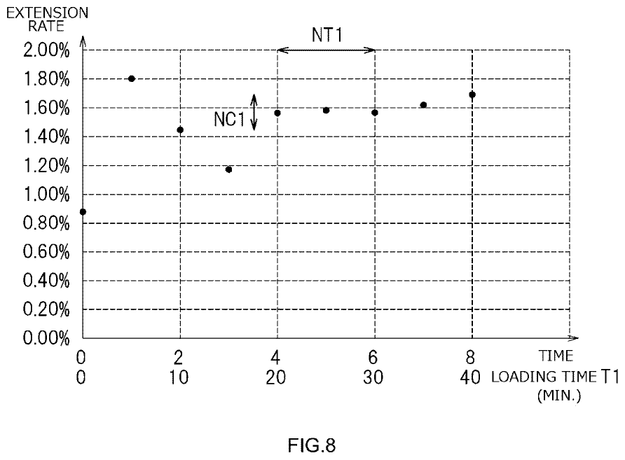

Creep removal of the target pressing rolls 62T as an example of rubber rolls is performed by applying a load to the target pressing rolls 62T in a predetermined loading time T1 (see FIG. 8). In this preferred embodiment, loading on the target pressing rolls 62T is performed by the roll pressing machine 60. In this example, the roll pressing machine 60 is an example of an extender as described above, but is an example of a preloader that applies a load to rubber rolls. The roll pressing machine 60 according to this preferred embodiment enables the extender and the preloader to be an identical device.

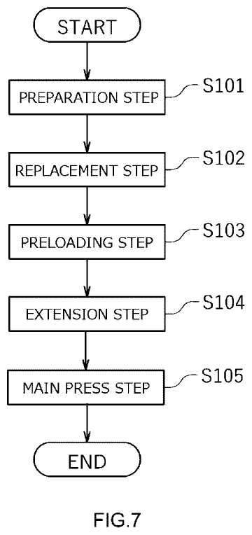

A method for processing the electrode sheet 10 according to this preferred embodiment will now be described with reference to the flowchart of FIG. 7. In this method for processing the electrode sheet 10, creep removal is performed on the new target pressing rolls 62T, the uncoated portions 12a of the electrode sheet 10 are extended, and the electrode sheet 10 is processed by using the target pressing rolls 62T subjected to the creep removal. As shown in FIG. 7, the method for processing the electrode sheet 10 includes preparation step S101, replacement step S102, preloading step S103, extension step S104, and main press step S105.

First, in preparation step S101, an electrode sheet 10 as a processing target is prepared. As illustrated in FIG. 2, the prepared electrode sheet 10 is a band-shaped sheet in which a current collector 12 of metal foil is coated with an electrode active material layer 14 and the current collector 12 includes uncoated portions 12a coated with no electrode active material layer 14. In this example, the electrode sheet 10 prepared in preparation step S101 is the electrode sheet 10 obtained through measuring step S2, kneading step S3, coating step S4, and drying step S5 in FIG. 1. That is, the electrode sheet 10 prepared in preparation step S101 is a non-extended sheet. In this preferred embodiment, in preparation step S101, new target pressing rolls 62T (see FIG. 5) to be replaced, for example, are prepared. The new target pressing rolls 62T herein are pressing rolls 62 in a state where extension of the uncoated portions 12a by pressing the pressing rolls 62 against the uncoated portions 12a of the electrode sheet 10 has not been performed yet. The new target pressing rolls 62T prepared in this step are an example of a replacement rubber roll.

Next, in replacement step S102 in FIG. 7, pressing rolls 62 already attached to the roll pressing machine 60 are replaced with the new target pressing rolls 62T. The new target pressing rolls 62T in this step are the target pressing rolls 62T prepared in preparation step S101. In this step, an operator detaches the already attached pressing rolls 62 from the roll pressing machine 60, and then attaches the new target pressing rolls 62T to the roll pressing machine 60. In this preferred embodiment, the target pressing rolls 62T replaced in replacement step S102 are not subjected to creep removal yet.

Then, in preloading step S103 in FIG. 7, a load is applied to the new target pressing rolls 62T to perform creep removal. This creep removal is performed by the roll pressing machine 60 as an example of a preloader. FIG. 8 is a graph showing a relationship between the time required for creep removal of the target pressing rolls 62T and an extension rate of the uncoated portions 12a of the electrode sheet 10. As shown in FIG. 8, the creep removal in this step means application of a load to the new target pressing rolls 62T such that the amount of change of the extension rate of the uncoated portions 12a extended by the new target pressing rolls 62T becomes less than or equal to a predetermined reference change amount NC1 in a predetermined reference time NT1. That is, when the amount of the extension rate of the uncoated portions 12a extended by the new target pressing rolls 62T in the reference time NT1 is the reference change amount NC1 or less, it is determined that the extension rate is stable and creep has been removed.

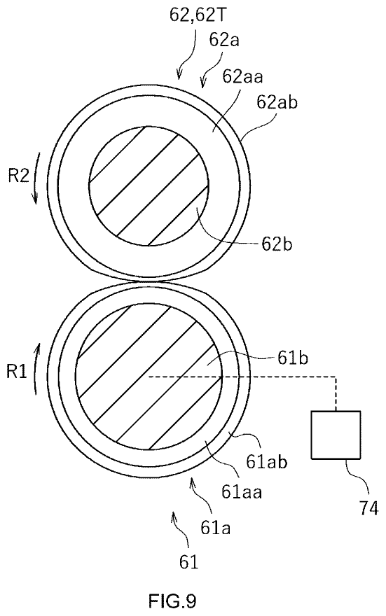

FIG. 9 illustrates a state where a load is applied to the target pressing rolls 62T in the roll pressing machine 60 and corresponds to FIG. 5. In this preferred embodiment, as illustrating FIG. 9, in the roll pressing machine 60, creep removal is performed on the target pressing rolls 62T in a state where the electrode sheet 10 is not supported by the support roll 61, that is, where the electrode sheet 10 is not disposed between the support roll 61 and the new target pressing rolls 62T. In this state, the preload controller 103 (see FIG. 6) of the controller 100 controls driving of the cylinder driver 73 (see FIG. 4) of the pressing force adjusting mechanism 70 to move the target pressing rolls 62T downward as illustrated in FIG. 9. Accordingly, the target pressing rolls 62T are brought into contact with the support roll 61. The pressing force of the target pressing rolls 62T against the support roll 61 at this time is, for example, 0.10 MPa to 0.80 MPa, preferably 0.15 MPa to 0.60 MPa, especially preferably 0.20 MPa to 0.40 MPa.

In this state where the target pressing rolls 62T are in contact with the support roll 61, the preload controller 103 controls the roll driver 74 and rotates the support roll 61. For example, the support roll 61 rotates in the direction of arrow R1. At this time, the target pressing rolls 62T rotate in synchronization with rotation of the support roll 61. The target pressing rolls 62T rotate in the direction of arrow R2. Since the target pressing rolls 62T rotate while being pressed against the support roll 61, a load is constantly applied to the target pressing rolls 62T from the support roll 61. The preload controller 103 rotates the support roll 61 in a loading time T1 (see FIG. 8). Accordingly, as shown in FIG. 8, the amount of change of the extension rate of the uncoated portions 12a extended by the new target pressing rolls 62T becomes less than or equal to the reference change amount NC1 in the reference time NT1, and the extension rate is stabilized. Thus, creep removal of the new target pressing rolls 62T can be performed. In this preferred embodiment, the reference time NT1 and the reference change amount NC1 are stored in the memory 101 of FIG. 6 beforehand.

The inventors of the present disclosure conducted a test on the loading time T1 in which a load is applied to the new target pressing rolls 62T until the extension rate of the uncoated portions 12a is stabilized. In this test, the support roll 61 is rotated with the new target pressing rolls 62T pressed against the support roll 61 by the roll pressing machine 60 as illustrated in FIG. 4 so that a load is thereby applied to the target pressing rolls 62T. Under a condition that the rotation speed of the support roll 61 at this time is 100 m/min and the pressing force in pressing the target pressing rolls 62T against the support roll 61 is 0.22 MPa, loading was performed eight times each for five minutes. FIG. 8 shows results. In the graph of FIG. 8, the abscissa represents the number of loading to the target pressing rolls 62T for five minutes (i.e., a total loading time T1), and the ordinate represents the extension rate of the uncoated portions 12a when the uncoated portions 12a of the electrode sheet 10 are extended by using the target pressing rolls 62T after each loading. This extension rate is calculated from (B/A)×100 where A is a length of the coated portion 12b yet to be extended and B is a length of the extended uncoated portions 12a, for example.

As shown in FIG. 8, in new target pressing rolls 62T to which no load was applied beforehand, that is, the number of loadings was zero, the extension rate of the uncoated portions 12a was about 0.8%. When the number of loading to the target pressing rolls 62T is one to three, the amount of change of the extension rate of the uncoated portions 12a was large. Thus, when the number of loadings is three, that is, the total loading time T1 is 5 minutes×3 times=15 minutes, the extension rate of the uncoated portions 12a is not stable, and it is considered that creep of the target pressing rolls 62T is not removed.

On the other hand, when the number of loadings to the target pressing rolls 62T was four or more, the extension rate of the uncoated portions 12a was around 1.6%, and the amount of change of the extension rate of the uncoated portions 12a in the predetermined reference time NT1 was less than or equal to the reference change amount NC1. In view of this, when the number of loadings is four or more, that is, the total loading time T1 is greater than or equal to 5 minutes×4 times=20 minutes, the extension rate of the uncoated portions 12a is stabilized, and creep of the target pressing rolls 62T is removed. For the foregoing reasons, when the loading time T1 in which a load is applied to the new target pressing rolls 62T is 20 minutes or more, creep of the target pressing rolls 62T is removed, and the extension rate of the uncoated portions 12a is stabilized.

Subsequently, in extension step S104 of FIG. 7, the uncoated portions 12a of the electrode sheet 10 are extended. In this step, the extension controller 105 (see FIG. 6) of the controller 100 presses the target pressing rolls 62T against the uncoated portions 12a of the electrode sheet 10 while conveying the electrode sheet 10, thereby extending the uncoated portions 12a. The target pressing rolls 62T used in this step are rolls subjected to creep removal, and are rubber rolls after a load has been applied such that the amount of change of the extension rate of the uncoated portions 12a extended by the target pressing rolls 62T is less than or equal to the reference change amount NC1 in the reference time NT1. These target pressing rolls 62T are not detached from the roll pressing machine 60 after creep removal, and are used in extension step S104.

In extension step S104, the extension controller 105 shown in FIG. 6 controls the cylinder driver 73 and the roll driver 74 as shown in FIG. 4. The cylinder driver 73 moves the rods 71a of the press cylinders 71 downward. The cylinder driver 73 moves the rods 71a downward to a predetermined position. Accordingly, the target pressing rolls 62T move downward. At this time, the roll driver 74 rotates the support roll 61. In this preferred embodiment, as illustrated in FIG. 5, the roll driver 74 rotates the support roll 61 in the direction of arrow R1. When the target pressing rolls 62T move downward, portions of the uncoated portions 12a sandwiched between the support roll 61 and the target pressing rolls 62T are compressed.

As illustrated in FIG. 5, near the uncoated portions 12a, the rubber portion 61ab of the support roll 61 and the rubber portions 62ab of the target pressing rolls 62T are deformed by compression. When the support roll 61 and the target pressing rolls 62T rotate, the compressed portions of the rubber portions 61ab return to the original shape by elasticity. At this time, portions of the rubber portions 61ab and 62ab moved to the vicinity of the uncoated portions 12a are compressed. Thus, while the support roll 61 and the target pressing rolls 62T rotate to convey the electrode sheet 10, the rubber portions 61ab and 62ab repeat elastic deformation along the circumferential direction of the support roll 61 and the target pressing rolls 62T near the uncoated portions 12a. In this manner, the uncoated portions 12a are extended by compression.

Thereafter, in main press step S105 in FIG. 7, after extension step S104, the electrode active material layer 14 (the coated portion 12b in this step) of the electrode sheet 10 is pressed. In main press step S105, the coated portion 12b is pressed by a dedicated device for pressing the coated portion 12b, for example. Accordingly, the coated portion 12b can be extended. Through the foregoing procedure, the electrode sheet 10 can be fabricated.

As described above, in this preferred embodiment, the method for processing the electrode sheet 10 includes preparation step S101 and extension step S104 as shown in FIG. 7. In preparation step S101, as shown in FIG. 2, the band-shaped electrode sheet 10 that is the electrode sheet 10 in which the current collector 12 of metal foil is coated with the electrode active material layer 14 and the current collector 12 includes the uncoated portions 12a not coated with the electrode active material layer 14. In extension step S104, as shown in FIG. 5, the pressing rolls 62 (e.g., the target pressing rolls 62T) are pressed against the uncoated portions 12a of the electrode sheet 10 while the electrode sheet 10 is conveyed so that the uncoated portions 12a are thereby extended. Extension step S104 uses the target pressing rolls 62T with which the amount of change of the extension rate of the uncoated portions 12a (see FIG. 8) becomes less than or equal to the predetermined reference change amount NC1 (see FIG. 8) in the predetermined reference time NT1 (see FIG. 8). In this manner, the uncoated portions 12a can be extended by using the target pressing rolls 62T processed to stabilize the extension rate of the uncoated portions 12a. Accordingly, variations of the degree of extension of the uncoated portions 12a can be reduced.

In this preferred embodiment, in replacement step S102 in FIG. 7, the pressing rolls 62 to be used in extension step S104 are replaced with new target pressing rolls 62T processed such that the amount of change of the extension rate of the uncoated portions 12a extended by the new pressing rolls 62 becomes less than or equal to the reference change amount NC1 in the reference time NT1. In this step, in preloading step S103 in FIG. 7, the pressing rolls 62 comes into a state of being replaced with the target pressing rolls 62T by applying a load to the pressing rolls 62. Through this replacement step S102, the pressing rolls 62 can be replaced with the target pressing rolls 62T capable of stabilizing the extension rate of the uncoated portions 12a.

In this preferred embodiment, in preloading step S103 of FIG. 7, as shown in FIG. 8, a load is applied to the target pressing rolls 62T until the amount of change of the extension rate of the uncoated portions 12a extended by the target pressing rolls 62T becomes less than or equal to the reference change amount NC1 in the reference time NT1. Extension step S104 in FIG. 7 uses the target pressing rolls 62T to which a load has been applied in preloading step S103. This application of a load to the target pressing rolls 62T can remove creep, and as a result, the extension rate of the uncoated portions 12a can be stabilized.

In this preferred embodiment, in preloading step S103, as illustrated in FIG. 9, a load is applied to the target pressing rolls 62T by rotating the new target pressing rolls 62T with the target pressing rolls 62T pressed against the support roll 61 as an example of a pressing target prepared beforehand. In this manner, by rotating the new target pressing rolls 62T with the new target pressing rolls 62T pressed against the support roll 61, a load can be applied to the target pressing rolls 62T.

In this preferred embodiment, the electrode fabrication system 1 includes the preloader and the extender. The preloader and the extender are an identical device and implemented by the roll pressing machine 60. The roll pressing machine 60 applies a load to the target pressing rolls 62T until the amount of change of the extension rate of the uncoated portions 12a extended by the target pressing rolls 62T in the reference time NT1 becomes less than or equal to the reference change amount NC1. The roll pressing machine 60 conveys the electrode sheet 10 with the target pressing rolls 62T pressed against the uncoated portions 12a of the electrode sheet 10 after application of a load to the target pressing rolls 62T. In extension step S104 in FIG. 7, as illustrated in FIG. 5, the electrode sheet 10 is conveyed with the uncoated portions 12a of the electrode sheet 10 sandwiched between the target pressing rolls 62T and the support roll 61. As described above, with one roll pressing machine 60, a load is applied to the target pressing rolls 62T to remove creep, and the uncoated portions 12a of the electrode sheet 10 are conveyed and extended with the target pressing rolls 62T from which creep has been removed.

In the preferred embodiment described above, the preloader and the extender are the identical device and implemented by the roll pressing machine 60. Alternatively, the preloader and the extender may be different devices. In this case, a load is applied to the new target pressing rolls 62T by the preloader to remove creep. After the target pressing rolls 62T subjected to creep removal have been detached from the preloader, the target pressing rolls 62T may be attached to the extender (e.g., the roll pressing machine 60) and pressed against the uncoated portions 12a of the electrode sheet 10 to thereby extend the uncoated portions 12a.

In the preferred embodiment described above, in applying a load to the new target pressing rolls 62T, the pressing target against which the target pressing rolls 62T are pressed is the support roll 61. However, the pressing target is not limited to a so-called roll, and may be, for example, a plate-shaped object that can apply a load to the target pressing rolls 62T.

In the preferred embodiment described above, the new target pressing rolls 62T are rotated while being pressed against the support roll 61 so that a load is thereby applied to the target pressing rolls 62T to remove creep. The method for applying a load to the new target pressing rolls 62T is not particularly limited. For example, a load may be applied to the target pressing rolls 62T by applying a physical impact to the new target pressing rolls 62T. Examples of the method for applying a physical impact include a method of hammering the target pressing rolls 62T with a tool such as a hammer and a method of vibrating the target pressing rolls 62T with a vibrator. Alternatively, a load may also be applied to the target pressing rolls 62T by heating the new target pressing rolls 62T with a heating device such as a heater. These methods for applying a load to the target pressing rolls 62T enable creep removal of the target pressing rolls 62T.

Various examples of the present disclosure has been described. The present disclosure is not limited to, for example, the preferred embodiment described here unless otherwise specified. The preferred embodiment disclosed here can be modified in various ways, and the constituent elements and the processes described here can be appropriately omitted or appropriately combined unless no particular problems arise.

As described above, the specification includes the disclosures described in the following items.

### Item 1:

A method for processing an electrode sheet includes:
a preparation step of preparing a band-shaped electrode sheet in which an electrode active material layer is located on a current collector of metal foil, and the current collector including a non-formed portion on which no electrode active material layer is located; and
an extension step of extending the non-formed portion by pressing a rubber roll against the non-formed portion of the electrode sheet while conveying the electrode sheet, wherein
the extension step uses the rubber roll with which an amount of change of an extension rate of the non-formed portion extended by the rubber roll becomes less than or equal to a predetermined reference change amount in a predetermined reference time.

### Item 2:

The method for processing the electrode sheet according to item 1, further includes a replacement step of replacing the rubber roll to be used in the extension step with a replacement rubber roll, the replacement rubber roll being processed such that the amount of change of the extension rate of the non-formed portion extended by the replacement rubber roll becomes less than or equal to the reference change amount in the reference time.

### Item 3:

The method for processing the electrode sheet according to item 1 or 2, further includes a preloading step of applying a load to the rubber roll until the amount of change of the extension rate of the non-formed portion extended by the rubber roll becomes less than or equal to the reference change amount in the reference time, wherein
the extension step uses the rubber roll to which a load has been applied in the preloading step.

### Item 4:

The method for processing the electrode sheet according to item 3, the preloading step, a load is applied to the rubber roll by rotating the rubber roll with the rubber roll pressed against a pressing target prepared beforehand.

### Item 5:

The method for processing the electrode sheet according to item 3, in the preloading step, a load is applied to the rubber roll by rotating the rubber roll with the rubber roll pressed against another rubber roll.

### Item 6:

The method for processing the electrode sheet according to item 5, in the extension step, the electrode sheet is conveyed with the non-formed portion of the electrode sheet sandwiched between the rubber roll and the other rubber roll.

### Item 7:

The method for processing the electrode sheet according to any one of items 1 to 6, further includes a main press step of pressing the electrode active material layer of the electrode sheet, after the extension step.

### Item 8:

An electrode fabrication system includes: a preloader that applies a load to a rubber roll until an amount of change of an extension rate of a non-formed portion of an electrode sheet extended by the rubber roll in a predetermined reference time becomes less than or equal to a predetermined reference change amount, the rubber roll being configured to be pressed against the non-formed portion in which a current collector of metal foil is exposed to extend the non-formed portion; and
an extender that conveys the electrode sheet with the rubber roll pressed against the non-formed portion of the electrode sheet after application of a load to the rubber roll by the preloader.

### Item 9:

The electrode fabrication system according to item 8, the preloader and the extender are an identical device.

### Item 10:

The electrode fabrication system according to item 8 or 9, the preloader includes a pressing target that rotates while being pressed against the rubber roll.

### Item 11:

The electrode fabrication system according to item 8 or 9, the preloader includes another rubber roll that rotates while being pressed against the rubber roll.

### Item 12:

The electrode fabrication system according to any one of items 8 to 11,
the extender includes
   a support roll that supports the electrode sheet and sandwiches the electrode sheet together with the rubber roll, and
   a conveyor that conveys the electrode sheet with the electrode sheet sandwiched between the rubber roll and the support roll.

What is claimed is:

1. A method for processing an electrode sheet, the method comprising:
a preparation step of preparing a band-shaped electrode sheet in which an electrode active material layer is located on a current collector of metal foil, and the current collector including a non-formed portion on which no electrode active material layer is located; and
an extension step of extending the non-formed portion by pressing a rubber roll against the non-formed portion of the electrode sheet while conveying the electrode sheet, wherein
the extension step uses the rubber roll with which an amount of change of an extension rate of the non-formed portion extended by the rubber roll becomes less than or equal to a predetermined reference change amount in a predetermined reference time.

2. The method for processing the electrode sheet according to claim 1, further comprising a replacement step of replacing the rubber roll to be used in the extension step with a replacement rubber roll, the replacement rubber roll being processed such that the amount of change of the extension rate of the non-formed portion extended by the replacement rubber roll becomes less than or equal to the reference change amount in the reference time.

3. The method for processing the electrode sheet according to claim 1, further comprising a preloading step of applying a load to the rubber roll until the amount of change of the extension rate of the non-formed portion extended by the rubber roll becomes less than or equal to the reference change amount in the reference time, wherein
the extension step uses the rubber roll to which a load has been applied in the preloading step.

4. The method for processing the electrode sheet according to claim 3, wherein in the preloading step, a load is applied to the rubber roll by rotating the rubber roll with the rubber roll pressed against a pressing target prepared beforehand.

5. The method for processing the electrode sheet according to claim 3, wherein in the preloading step, a load is applied to the rubber roll by rotating the rubber roll with the rubber roll pressed against another rubber roll.

6. The method for processing the electrode sheet according to claim 5, wherein in the extension step, the electrode sheet is conveyed with the non-formed portion of the electrode sheet sandwiched between the rubber roll and the other rubber roll.

7. The method for processing the electrode sheet according to claim 1, further comprising a main press step of pressing the electrode active material layer of the electrode sheet, after the extension step.

8. An electrode fabrication system comprising:
a preloader that applies a load to a rubber roll until an amount of change of an extension rate of a non-formed portion of an electrode sheet extended by the rubber roll in a predetermined reference time becomes less than or equal to a predetermined reference change amount, the rubber roll being configured to be pressed against the non-formed portion in which a current collector of metal foil is exposed to extend the non-formed portion; and
an extender that conveys the electrode sheet with the rubber roll pressed against the non-formed portion of the electrode sheet after application of a load to the rubber roll by the preloader.

9. The electrode fabrication system according to claim 8, wherein the preloader and the extender are an identical device.

10. The electrode fabrication system according to claim 8, wherein the preloader includes a pressing target that rotates while being pressed against the rubber roll.

11. The electrode fabrication system according to claim 8, wherein the preloader includes another rubber roll that rotates while being pressed against the rubber roll.

12. The electrode fabrication system according to claim 8, wherein
the extender includes
a support roll that supports the electrode sheet and sandwiches the electrode sheet together with the rubber roll, and
a conveyor that conveys the electrode sheet with the electrode sheet sandwiched between the rubber roll and the support roll.
